(19) United States
(12) Patent Application Publication
(10) Pub. No.: US 2002/0188236 A1
(43) Pub. Date: Dec. 12, 2002

(54) Multi-functional device with functions of abdomen-health and waist-tightening and massage

(76) Inventor: Chang I. Lin, Taipei (TW)

Correspondence Address: Chang I. Lin, P.O. Box 26-757, Taipei, 106, TW

(21) Appl. No.: 09/879,259

(22) Filed: Jun. 11, 2001

(51) Int. Cl. A61H 23/00

(52) U.S. Cl. 601/107

(57) ABSTRACT

A multi-functional device with functions of abdomen-health and waist-tightening and massage is disclosed. The device includes a main body, a guide rod, a cushion, a highly-extendable belt, an air absorbing unit and an inflation belt. The air absorbing unit is installed between the main body and the guide rod. The cushion is combined with an inflation belt. When user's hand holds the holding portion and resists the cushion against the user's abdomen, the hands and abdomen of the user can apply forces so that the main body and cushion can adhere to one another. Furthermore, by the restoring force of highly-extendable belt, a reciprocal movement is applied continuously to achieve the required object of sports. Therefore, the device has functions of abdomen-health and waist-tightening and massage. As a result, the user is unnecessary to buy various kinds of exercise machine for reducing the economic burden.

### FIELD OF THE INVENTION

The present invention relates to a multi-functional device with functions of abdomen-health and waist-tightening and massage, and especially to device with functions of abdomen-health and waist-tightening and massage without needing any power.

### BACKGROUND OF THE INVENTION

With the advance of the modern society, people have less time to exercise so as to induce many problems about the health of human body. Therefore, many different kinds of exercise devices are developed.

Many different kinds of exercise devices are commercially sell, such as that disclosed in Taiwan Patent Publication Nos. 280187, 305210, 344297, for providing the function of removing undesired fats on the abdomen. These devices mainly have a main body, a guide rod, a cushion, and a highly-extendable belt. Each of two sides of the main body is installed with a holding piston for being held by hands. The guide rod is slidably matched to be between the main body and the guide rods. When user's hand holds the holding portion and resists the cushion against the user's abdomen, the hands and abdomen of the user can apply forces, so that the main body and cushion can adhere to one another, furthermore, by the restoring force of highly-extendable belt, a reciprocal movement is applied continuously to achieve the required object of sports.

However, the above prior art exercise device has only the effect of abdomen health, while other multi-functional device with functions of for example waist-tightening and massage are lack. If the user needs these functions, the user must buy various devices having such functions, while the burden in economics is heavy.

A prior art electronic inflation belt has the function of abdomen-tightening and waist massage, while it is inflated electrically. The air will drain out as no power is supplied and thus it can not be used for a longer time.

### SUMMARY OF THE INVENTION

Accordingly, the primary object of the present invention is to provide a multi-functional device with functions of abdomen-health and waist-tightening and massage, wherein other than having a function of abdomen-health of a general abdomen exercise machine, in the operation of abdomen health process, the air absorbing unit may absorb air so that the inflation belt will inflate. Therefore, the present invention has functions of abdomen-health and waist-tightening and massage. Therefore, the user is unnecessary to buy various kinds of exercise machine for reducing the economic burden. The inflation of the inflation belt is performed in the operation process, no power is required. Therefore, no problem of air draining occurs. The effect of abdomen tightening is maintained. Therefore, the air will not drain out due to no power. Furthermore, since the air is inflated reciprocally, the inflation belt has a massage effect.

To achieve the objects, the present invention provides a multi-functional device with functions of abdomen-health and waist-tightening and massage. The device includes a main body, a guide rod, a cushion, a highly-extendable belt, an air absorbing unit and an inflation belt. The air absorbing unit is installed between the main body and the guide rod. The cushion is combined with an inflation belt. When user's hand holds the holding portion and resists the cushion against the user's abdomen, the hands and abdomen of the user can apply forces so that the main body and cushion can adhere to one another, furthermore, by the restoring force of highly-extendable belt, a reciprocal movement is applied continuously to achieve the required object of sports. Therefore, the undesired portion of the abdomen can be removed. Therefore, device has functions of abdomen-health and waist-tightening and massage. Therefore, the user is unnecessary to buy various kinds of exercise machine for reducing the economic burden.

The various objects and advantages of the present invention will be more readily understood from the following detailed description when read in conjunction with the appended drawing.

### BRIEF DESCRIPTION OF THE DRAWINGS

FIG. 1 is an exploded assembly view of the present invention.

FIG. 2 is an exploded perspective view of the present invention.

FIG. 3 is a transversal cross sectional view of the present invention.

FIG. 3A is a cross sectional view along line A-A of FIG. 3.

FIG. 4 is a longitudinal cross sectional view of the present invention.

FIG. 5 is a perspective view of the inflation belt according to the present invention.

FIG. 6 is a schematic perspective view showing the application of the present invention.

FIG. 7 is a schematic cross sectional view of the application of the present invention.

FIG. 8 is another schematic cross sectional view of the application of the present invention.

### DETAILED DESCRIPTION OF THE PREFERRED EMBODIMENTS

To more understand the present invention by those skilled in the art, in the following, the details will be described with the appended drawings. However, all these descriptions are used to make one fully understand the present invention, while not to be used to confine the scope of the present invention defined in the appended claims.

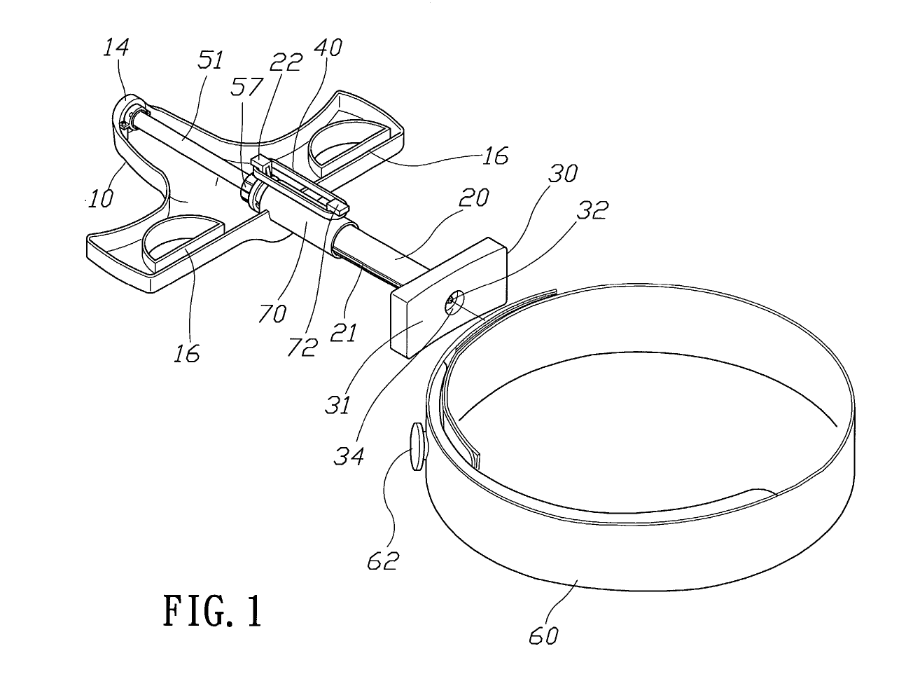

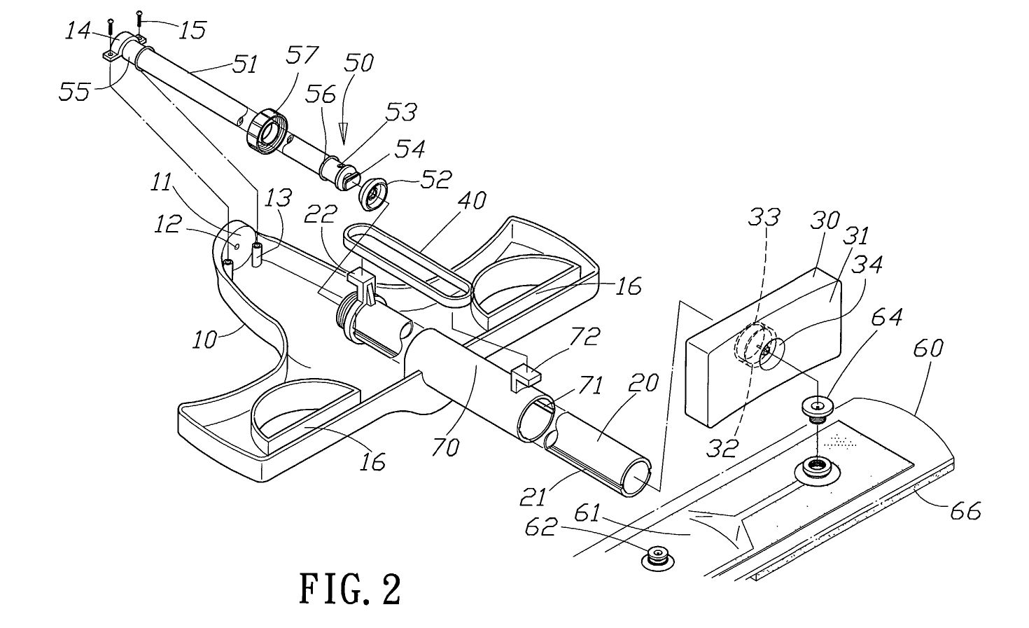

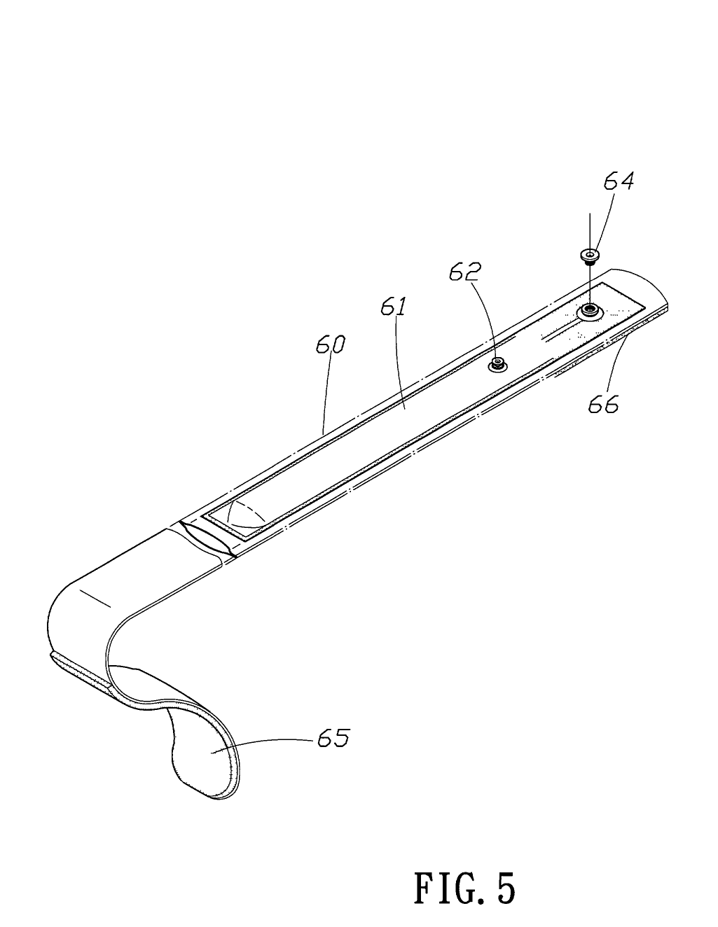

Referring to FIGS. 1 to 5, a multi-functional device with functions of abdomen-health and waist-tightening and massage of the present invention is illustrated. The multi-functional device with functions of abdomen-health and waist-tightening and massage according to the present invention includes a main body 10, a guide rod 20, a cushion 30, at least one highly-extendable belt 40, an air absorbing unit 50, an and an inflation belt 60. The main body 10 is a casing symmetrically at right and left sides. A front end thereof is installed with a retaining block 11. The retaining block 11 is installed with an air inlet 12. Near the front end of the main body 10 is installed with two first studs 13. A first press plate 14 is penetratable by two first screws 15 to screwedly connect to the first stud 13. Two sides of the main body 10 each are installed with a holding portion 16 for being held by the user's hand.

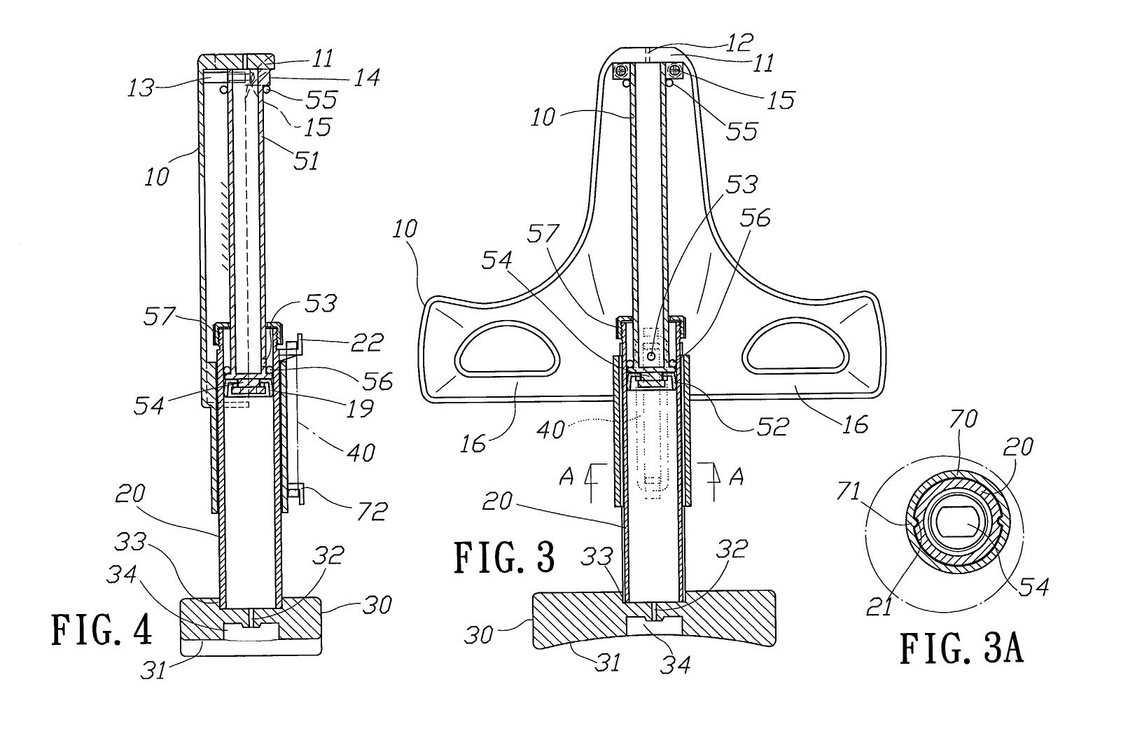

Near the rear end of the main body 10 is firmly secured with a sleeve 70. The sleeve 70 is a hollow post, and rear end thereof is protruded from the main body 10 with a proper length. The inner wall of the sleeve 70 is protruded with two guide tracks 71 (referring to FIG. 3A). Each guide track 71 is axially extended from the sleeve 70. Near the rear end of the outer wall of the sleeve 70 is protruded with a first hook 72.

The guide rod 20 is a hollow round post and is slidably matched to the interior of the sleeve 70, so that the guide rod 20 is slidabley matched to the main body 10. The outer wall of the guide rod 20 are protruded with two guide grooves 21. The two guide grooves 21 are axially extended along the guide rods 20 and are correspondent to the two guide tracks 71. The two guide tracks 71 are matched to the two guide grooves 21 for guiding the guide rod 20 to be axially moved with the main body 10, thereby, no rotation occurs between the two. The outer wall of the guide rod 20 has a second hooks 22 near the front end.

The cushion 30 has an approximately oblong shape. The rear side thereof can be formed as a concave cambered shape 31 according to requirement of ergonomics, so that the cushion 30 can be properly resists against the abdomen of the user. The middle part of the cushion 30 is installed with a vent 32. A front end and rear end of the vent are connected with a first connecting groove 33 and a second connecting groove 34. The first connecting groove 33 serves to be inserted by the rear end of the guide rod 20 so that the rear end of the guide rod 20 is combined with the cushion 30.

The highly-extendable belt 40 is made of material of high tension, such as plastics and has a circle shape. The highly-extendable belt 40 is arranged between the first hook 72 and the second hook 22, so that the highly-extendable belt 40 is installed between the sleeve 70 of the main body 10 and the guide rod 20.

The air absorbing unit 50 is formed by an inner tube 51 and a piston 52. The inner tube 51 is a hollow round post. The first press plate 14 is penetrated by two second screws 15 to be fixed to the first stud 13, thereby, in the front end of the inner tube 51, the first press plate 14 is pressed and fixed to the main body 10. The front end of the inner tube 51 has an opening. The front end of the inner tube 51 is connected to the air inlet 12. Near the rear end of the inner tube 51 is installed with a through hole 53. The through hole 53 penetrates through the inner and outer walls of the inner tube 51. The rear end of the inner tube 51 is installed with a buckling seat 54. The piston 52 is buckled to the buckling seat 54 at the rear end of the inner tube 51. The outer wall of the piston 52 has a proper taper shape, so that air only unidirectionally enters into the interior of the guide rod 20 between the piston 52 and the inner wall of the guide rod 20. Air can not flow out from the inner wall between the piston 52 and the guide rod 20. Besides, near the front and rear ends of the inner tube 51 are engaged with O rings 55 and 56. The rear end of the inner tube 51 is inserted into the guide rod 20. A front end of the guide rod 20 is screwedly connected to an end cover 57 for being positioned therein for preventing that the rear end of the inner tube 51 and the piston 52 separates from the interior of the guide rod 20.

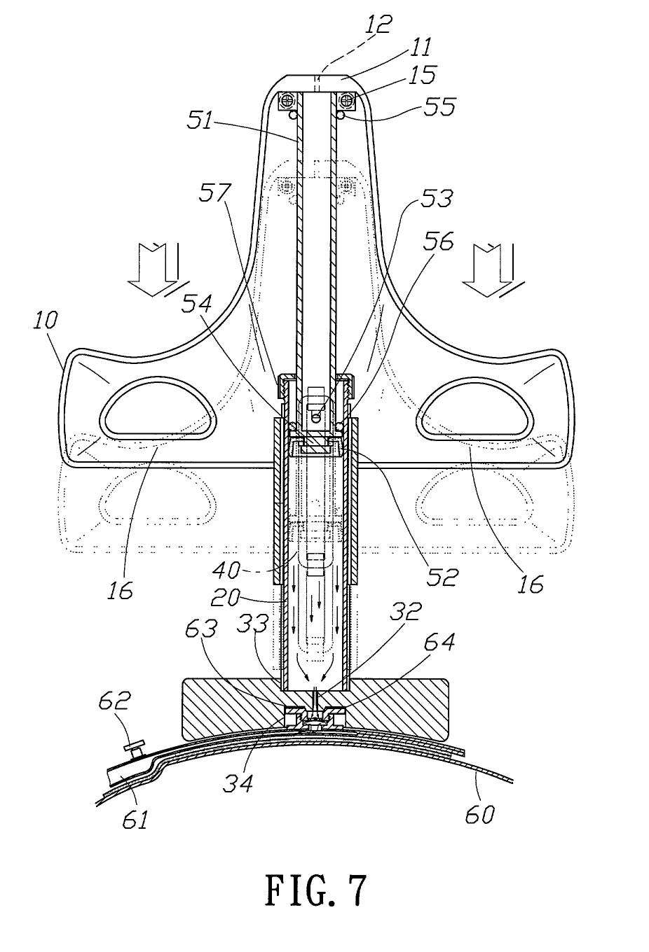

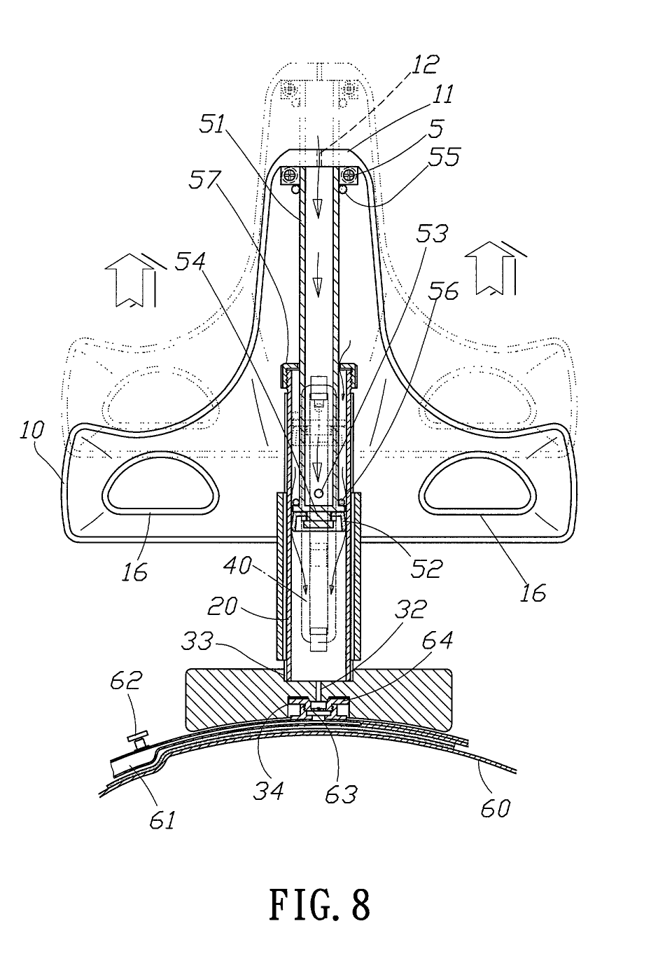

The inflation belt 60 is made of flexible material. The interior of the inflation belt 60 is installed wit an air bag 61. The air bag 61 is combined with an air inlet valve 64. The interior of the air inlet valve 64 is installed with a check valve piece 63 (referring to FIGS. 7 and 8), so that air only fills into the air bag 61 unidirectionally. When air is desired to be vented out from the air inlet valve 64. The air will push the check valve piece 63 to seal the air inlet valve 64 so as to avoid the air in the air bag 61 drains out from the air inlet valve 64. The air inlet valve 64 is inserted into the second connecting groove 34 of the cushion 30 so that the inflation belt 60 is connected to the vent 32 of the cushion 30. The air bag 61 is combined with an air drain valve 62. When the air drain valve 62 is opened, the air in the air bag 61 will be drained out. Further, two ends of the inflation belt 60 are installed with respective sticky belts 65 and 66. Thereby, as the inflation belt 60 encloses the waist of the user, by the connecting of the sticky belts 65 and 66, a connection device is formed, thereby, the inflation belt 60 can be fixed to the waist of the user. By above components, the multi-functional device with functions of abdomen-health and waist-tightening and massage of the present invention is formed.

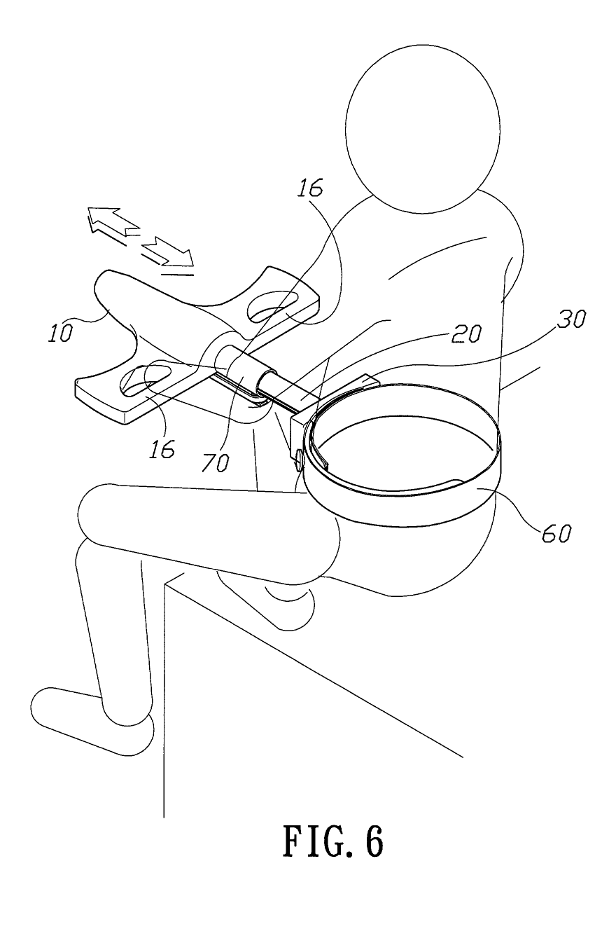

Referring to FIG. 6, when user's hand holds the holding portion 16 and resists the cushion 30 against the user's abdomen, the hands and abdomen of the user can apply forces, so that the main body 10 and cushion 30 can adhere to one another, furthermore, by the restoring force of highly-extendable belt 40, a reciprocal movement is applied continuously to achieve the required object of sports. Therefore, the undesired portion of the abdomen can be removed.

With reference to FIGS. 7 and 8, when the main body 10 is adhered to the cushion 30, by the restoring force of the highly-extendable belt 40 to be moved repeatedly, the air absorbing unit 50 will generate an air absorbing effect, so that the inflation belt 60 is inflated gradually. When the main body 10 and cushion 30 are adhered together (referring to FIG. 7), the inner tube 51 may drive the piston 52 to move rearwards in the guide rod 20 for pushing the air in the guide rod 20 to be exhausted out from the air outlet 32 through the cushion 30. Thereby, air fills into the air bag 61 from the air inlet valve 64.

When the main body 10 and cushion 30 are restored by the restoring force of the highly-extendable belt 40 (referring to FIG. 8), the inner tube 51 will drive the piston 52 to move forwards in the guide rod 20, so that a negative pressure is generated within the guide rod 20. Therefore, outer air can be absorbed into the inner tube 51 from the air inlet 12 and further flows through the through hole 53 and between the inner walls of the piston 52 and the guide rod 20 to enter into the interior of the guide rod 20. Thereby, when the main body 10 is combined with the cushion 30, air within the guide rod 20 is filled into the air bag 61. Therefore, by combining the main body 10 and cushion 30, and the restoring force of the highly-extendable belt 40 to move reciprocally, the inflation belt 60 is inflated. The user may drain air in the air bag 61 out through the air drain valve 62 for controlling the air amount in the air bag 61. By the inflation effect of inflating air reciprocally, the inflation belt has a massage effect.

In the present invention, other than having a function of abdomen-health of a general abdomen exercise machine, in the operation of abdomen health process, the air absorbing unit 50 may absorb air, so that the inflation belt 60 will inflate. Therefore, the present invention has functions of abdomen-health and waist-tightening and massage. Therefore, the user is unnecessary to buy various kinds of exercise machine for reducing the economic burden.

The inflation of the inflation belt 60 is performed in the operation process, no power is required. Therefore, no problem of air draining occurs. The effect of abdomen tightening is maintained.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. The multi-functional device with functions of abdomen-health and waist-tightening and massage comprising:
a main body having two sides each being installed with a holding portion, a sleeve being fixed on the main body;
a guide rod slidable matching to an interior of the sleeve;
a cushion installed with a vent; the cushion being connected to a rear end of the guide rod;
at least one highly-extendable belt installed between the sleeve and guide rod;
an air absorbing unit formed by an inner tube and a piston, the inner tube being fixed to the main body; the piston being combined to the inner tube; a rear end of the inner tube being inserted into an interior of the guide rod; and
an inflation belt having an air bag therewithin; the air bag being combined to an air inlet valve and an air draining valve; the air inlet valve being connected to the vent of the cushion.

2. The multi-functional device with functions of abdomen-health and waist-tightening and massage as claimed in claim 1, wherein a front end of the main body is installed with an air inlet hole, a front end of the inner tube is connected to the air inlet hole.

3. The multi-functional device with functions of abdomen-health and waist-tightening and massage as claimed in claim 1, wherein near a front end of the main body is installed with two second first stud, the inflation belt is pressed by a first press plate; the two first stud penetrates through the first press plate to be screwedly fixed to the first stud so that the front end of the inner tube is fixed to the main body by the first press plate.

4. The multi-functional device with functions of abdomen-health and waist-tightening and massage as claimed in claim 1, wherein guide tracks are protruded from an inner wall of the sleeve of the main body, the guide tracks are axially extended along the sleeve; an outer wall of each guide track is formed with a guide groove which is axially extended along the guide rod; and the guide track is matched to the guide groove.

5. The multi-functional device with functions of abdomen-health and waist-tightening and massage as claimed in claim 1, wherein near a rear end of an outer wall of the sleeve is installed with a first hook; near an front end of the outer wall of the guide rod is installed with a second hook; and the highly-extendable belt is engaged between the first hook and the second hook.

6. The multi-functional device with functions of abdomen-health and waist-tightening and massage as claimed in claim 1, wherein a rear side thereof is formed as a concave cambered shape; a front end and rear end of the vent are connected with a first connecting groove and a second connecting groove; a first connecting groove serves to be inserted by the rear end of the guide rod so that the rear end of the guide rod is combined with the cushion; and the second connecting groove is connected to the inflation belt so that the inflation belt is connected to the vent of the air outlet hole.

7. The multi-functional device with functions of abdomen-health and waist-tightening and massage as claimed in claim 1, wherein a front end of the inner tube of the air absorbing unit has an opening; near a rear end of the inner tube is formed with a through hole; the rear end of the inner tube is installed with a buckling seat; the piston is buckled to the buckling seat; an outer wall of the piston has a proper taper shape; besides, the inner tube is engaged with O rings; and a fornt end of the guide rod is screwedly connected with an end cover.

8. The multi-functional device with functions of abdomen-health and waist-tightening and massage as claimed in claim 1, wherein the inflation belt is made of flexible material; an interior of the air inlet valve is installed with a check valve piece; the air inlet valve is inserted into the cushion so that the inflation belt is connected to the vent of the cushion.

9. The multi-functional device with functions of abdomen-health and waist-tightening and massage as claimed in claim 1, wherein two ends of the inflation belt are installed with respective sticky belts, by two ends of the sticky belts, the inflation belt is fixed to the waist.
